(19) United States
(12) Patent Application Publication
(10) Pub. No.: US 2014/0143016 A1
(43) Pub. Date: May 22, 2014

(54) METHOD AND SYSTEM FOR IMPLEMENTING PROGRESSIVE PROFILING OF POTENTIAL CUSTOMERS

(71) Applicant: Brett Clyde Walker, Provo, UT (US)

(72) Inventor: Brett Clyde Walker, Provo, UT (US)

(21) Appl. No.: 13/681,419

(22) Filed: Nov. 19, 2012

(51) Int. Cl. G06Q 30/02

(52) U.S. Cl. CPC G06Q 30/0203; G06Q 30/0201
USPC 705/7.32; 705/7.29

(57) ABSTRACT

Access to valuable website content is restricted until an individual registers and provides contact and other information relevant to his company and his position. If an unregistered individual attempts to access restricted information, he is automatically taken to an information request page. Once he has completed the page, he is taken to a thank you page, then redirected to the desired restricted content. The user is also sent an automatic email which contains a website access code. A registered visitor also retains access to restricted content through a long-term cookie delivered to his Internet browser. Progressive profiling can be implemented by tying access to higher-value website content to a requirement for input of additional information, so that new visitors are not overloaded with an initial barrage of questions. Received visitor information is transferred to a Customer Relationship Management database for scoring and ranking.

This application has a priority date of Nov. 18, 2011 based on the filing, by the same inventor, of Provisional Patent Application No. 61/561,292, titled METHOD AND SYSTEM FOR IMPLEMENTING PROGRESSIVE PROFILING OF POTENTIAL CUSTOMERS.

### FIELD OF THE INVENTION

The present invention relates, generally, to systems for generating customer leads and, more particularly, to a system which progressively profiles potential customers by providing increasingly less-restricted, tiered access to on-line information in response to required level-specific inputs of increasingly-detailed business information.

### BACKGROUND OF THE INVENTION

Most small and medium sized companies face similar challenges in developing successful marketing and sales campaigns. These challenges include locating qualified prospects who are making immediate buying decisions. It is desirable to personalize marketing and sales information to match those prospects, and to deliver the marketing and sales information in a timely and compelling manner. Other challenges are to assess current customers to determine which customer profile produces the highest net revenue, then to use those profiles to maximize prospecting results. Further challenges are to monitor the sales cycle for opportunities and inefficiencies, and to relate those findings to net revenue numbers.

For more than a century, many businesses have relied on non-targeted advertising systems such as mass mailings to a general geographic area. Telemarketing programs have also been used extensively since the mid-twentieth century. Although mass mailings and telemarketing may be used to sell products and services to willing customers, these marketing methods require businesses to contact all potential customers without any knowledge as to the likelihood that any particular one will purchase a specific product or service. Typically, information used to set up a mass mailing or telemarketing campaign is segmented demographically to improve the efficiency of the mailing. The reasons for these inefficiencies include the fact that measurement and feedback is a slow manual process that is limited in the depth of analysis. Another reason is that data collected from different consumer contact points are not integrated and thus does not allow a marketing organization a full consumer view. Thus, these approaches lack the ability to target specific potential customers for specific products or services.

More sophisticated marketing strategies involve selecting a particular group based on demographics or other characteristics, and directing the marketing effort to that group. However, known methods typically do not provide for proactive and effective consumer relationship management or segmentation of the consumer group to increase efficiency and returns on the marketing campaign.

The consequences of inefficient marketing processes include loss of market share, increased attrition rate among profitable customers, and slow growth and reduction in profits.

Surveys and other data collection techniques have been used extensively in the field of marketing research. Traditional forms of surveying or data collection are plagued with many problems, at least three of which result in severe inefficiencies. Firstly, traditional surveys, such as telephone surveys or face-to-face surveys conducted in public places such as shopping malls produce a very small number of participants relative to the number of people solicited. Secondly, many of those who are contacted find such unsolicited contact offensive, which could result in negative publicity for the product or organization for which the survey is being conducted. Thirdly, the low response rate to a traditional survey is compounded by the fact that a large percentage of the people completing the survey may not be members of a desired target audience. As a result, traditional surveying or data collecting techniques are expensive and time consuming relative to the amount of good quality relevant data collected.

In early twenty-first century, companies have access to an overwhelming amount of marketing information that continues to grow exponentially. Many businesses now purchase compiled statistical data for the purpose of better targeting their marketing campaigns. However, the data obtained by current collection methods is limited, in that the research is typically based on small samples of the population and is typically historical data. Thus, the data is generalized and does not give the businesses any information regarding the desires or needs of specific potential customers.

With the explosive growth of the Internet during the past twenty years, it has become increasingly popular to gather customer information by accessing Internet data sources. However, Internet data intelligence and data mining operations face specific challenges. Firstly, they tend to be designed for use by technicians, and are not flexible or intuitive in their operation; secondly, the technologies behind the various engines are changing rapidly to take advantage of advances in hardware and software; and thirdly, the results of harvesting and mining are typically not focused on a particular business product or line of business.

Many website owners desire to collect information regarding usage of their websites. For example, an Internet website owner might use a third party service to track the number of users that visit its website, the number of selections these users collectively perform (using their touch screen or mouse/trackball pointers) while visiting the website, and how long these users stay at the website. Using this objective information, the website owner may determine that its website is not attracting a sufficient number of users or has been ineffective at keeping the interest of users once they arrive. The website owner may react accordingly to improve its websites and, possibly, the success of its associated business operations.

Previous techniques for obtaining information concerning usage of websites often do not provide website owners with information about how individual users subjectively react to their websites, making the information of minimal value. Prior techniques that do solicit subjective user reactions do so with respect to transactions carried out using the website, but not with respect to the visitors, themselves. These techniques give website owners little if any information concerning subjective reactions of individual, or named, users to particular pages of their websites. Moreover, website owners are given little, if any, information about how individual users experience their websites as those users navigate through them, moving from page to page according to the topography of the websites. Even techniques that request users to provide subjective reactions concerning transactions may be relatively difficult to use, obtrusive, unstandardized, or otherwise deficient in some manner that causes them to be seldom used and therefore ineffective. The information reported to website owners may also be ineffective due to the format in which it is provided, for example, in reports that are difficult to interpret and do not allow useful comparisons to be made. These and other disadvantages make prior techniques inadequate for many website owners.

Therefore, a need has arisen for a new system and method for profiling customers for targeted marketing that overcomes the disadvantages and deficiencies of prior art systems and methods.

### SUMMARY OF THE INVENTION

The present invention provides a method and system for profiling potential customers that is implemented by tracking an individual's access to web content (by IP address or other means) and by optionally restricting access to valuable website content until an individual registers and provides contact information and other information relevant to his company and his position within that company. An Internet Protocol address, or IP address, is a numerical label assigned, at the time of manufacture, to each device (e.g., computer, printer) that it is anticipated will participate in computer networks. An IP address serves two principal functions: (1) host or network interface identification and (2) location addressing IP address. Although descriptions of document, videos, web pages, external links and other forms of web content may be provided to unregistered individuals who access the website, access to those items can be restricted until registration is complete. Thus, if an individual has not registered and attempts to access restricted website content, he/she is automatically taken to an information request page or form. Once he/she has completed the page, he is optionally taken to a thank you page, then redirected to the desired restricted content. The default operation enables a registered website visitor to gain immediate and automatic future access to the restricted content by means of a long-term cookie that is delivered to his/her Internet browser. From the moment the visitor's browser accepts the cookie, he/she has access to restricted content without having to manually log in. The entire website essentially becomes accessible. Nevertheless, the user may also be sent an automatic email which contains details of his/her registration and an access code for future access to the website content to which access is restricted. Thus, a user who has customized his Internet browser to reject cookies will still be able to gain access to the restricted information by manually inputting his login name and access code.

Alternatively, website content to which access is restricted can be assigned multi-tier accessibility. In other words, instead of initially overloading a new visitor to the website with a barrage of questions, the profiling is effected in a progressive manner. Access to website content is allowed in stages, with each stage of allowance following the answering of particular questions. Thus, cookies offered to a registrant's web browser, in a system of multi-tier accessibility, restrict access to only those levels for which the individual has qualified. When that individual achieves a new level of access by providing additional profiling information, a new updated cookie is offered to his browser that will replace a previously accepted cookie. Alternatively, the existing cookie can be updated for greater website access. Typically, the most desirable website content is made accessible only after collection of all essential information that is relevant to the efficient and accurate profiling of a particular individual. Progressive profiling of an already-registered visitor can be handled with secondary forms that pop up and ask additional questions or offer suggestions or other links on subsequent visits. Visitor activity on a profiling website can be tracked by visitor name using a single light (non-burdensome) fill-out form and long-term cookie. For individuals who have programmed their Internet browsers to not accept cookies, only session data (mouse clicks and time spent on particular subjects) is tracked. Certain links on the website can be programmed locally or remotely (i.e., in the “cloud”) to trigger the pop-up of a form, while other links would simply be tracked without triggering a pop-up.

Progressive profiling can also be implemented or supplemented by forming behavioral conclusions about the visitor, based on the pattern of content selections while browsing the website (e.g., government-oriented clicks vs. private-sector-oriented clicks), and then adding that association to that visitor's stored profile. Progressive profiling of visitors can also be supplemented by allowing third-parties to contribute relevant data to existing profiles via an application programming interface. Such data may include IP address, company information, information from the user's Customer Relationship Manager (CRM) account, answers to web site polls, survey questions, webinar participation statistics, and other information which assists in the identification of specific interests professional foci of particular visitors.

Tracking across any web service can be provided as long as those web services are called out by links (i.e., Uniform Resource Locators, or URLs) associated with the base website. In other words, embedded constructs within the links or URLs enable the visitor to be handed off to another website, including webinar hosting services and social media websites and then returned to the base website when a particular off-site service is completed. Tracking of the visitor's selections while on the off-site service can be maintained through the embedded constructs. In addition, embedded constructs can be contained within links in email solicitations sent to former website visitors and potential visitors. Those constructs can be used to track visitor preferences if the email recipient chooses to click on the link. The embedded constructs function independently of the email service provider. As long as a visit to a third-party web service is initiated within the base website through a link containing an embedded construct, or by means of a link in some other message or document (e.g. a delivered email message), which contains an embedded construct, tracking of activity of interested individuals can be implemented.

As information is received from or about a visitor, it is transferred to a database. As a rule, access to website content can be restricted until a certain cumulative score threshold has been reached and the visitor has disclosed all desired information. Each visitor record contains a history of all website activity, downloads, site visits, and even external web or email campaigns. Database functions are used to score and rank leads as a function of accessed content and links, send automatic email messages, and take any other desired actions (including on-going customer campaigns). The scoring (raw values) and ranking (categorical values such as cold, warm, hot) of tracked activities are stored by visitor name. Scoring and ranking can be performed based on customer-specific business rules, statistical events, or best practice business rules which specify when and how to engage visitors so as to produce a desired outcome. Scoring and ranking can also be weighted by third party indices (e.g., consumer confidence index) or “climate” data (e.g., buying patterns by geography, culture, etc.). On a return visit, Web content can then be dynamically adjusted as a function of a visitor's profile, score, and rank. Such content may include welcoming information, as well as specific website content that is selected on the basis of a visitor's profile or profile category. In addition, a visitor's profile or profile category can be used to serve him with specific e-mail content or specific advertising campaigns.

The scope and coverage of profiling system can be enhanced by allowing affiliated, or partner, website owners to participate in a professional profiling exchange or interchange network. Within such a network, a visitor authenticated by one website would not be required to fill out an identifying and profiling form when visiting an affiliate website within the network. Profile data is shared by among partners or affiliates within the network based on a set of rules agreed to by all members of the network. Shared profile date can be limited to demographics, psychographics, behavioral data, scores, and similar data extractions. In such a network, the profile data is centrally owned and stored in a central location accessible to all network members (i.e., in the cloud).

In addition, data acquired by the profiling system can be used to enhance or tune programs or efforts aimed at attracting visitors to a website or content owned by the website owner, but placed elsewhere online. The effect of the tuning and enhancement is a reduction in on-going marketing costs and growth of a website owner's email list. Furthermore, new analytics can be produced which optimize the placement of acquisition and profiling forms, foster the creation of content aimed at increasing the lead acquisition rate, and track the increasing engagement level of profiled visitors as score (raw values) and rank (categorical values, such as cold, warm, hot) to better inform the website owner about the efficiency and effectiveness of the website. Fully profiled visitors can be delivered to other functions in the organization (such as the sales department) in order to solicit feedback, which can be used to optimize the scoring and ranking settings of the profiling system, and for use in prospecting and developing business opportunities.

### BRIEF DESCRIPTION OF THE DRAWINGS

FIG. 1 is a flow chart of the basic method and system for implementing progressive profiling of potential customers; and

FIG. 2 is a flow chart that shows how various client websites can be coupled to and communicate with the A4 server, which handles set up, tracking, scoring, reporting, and administration of the profiling process.

### PREFERRED EMBODIMENT OF THE INVENTION

The present invention provides a method and system for implementing progressive profiling of potential customers for the purpose of developing customer leads who are likely to have a strong interest in products and/or services provided by a company which hosts a marketing-directed website. The method and system preferably operate in the context of a hosting service, in which Internet websites of affiliate, partner or subscriber business entities contract with the hosting service for progressive profiling features provided, which can be customized to fit particular needs of an affiliate, partner or subscriber business entity (hereinafter “subscribing entity”). The method and system will now be described in detail, with reference to the attached drawing figures.

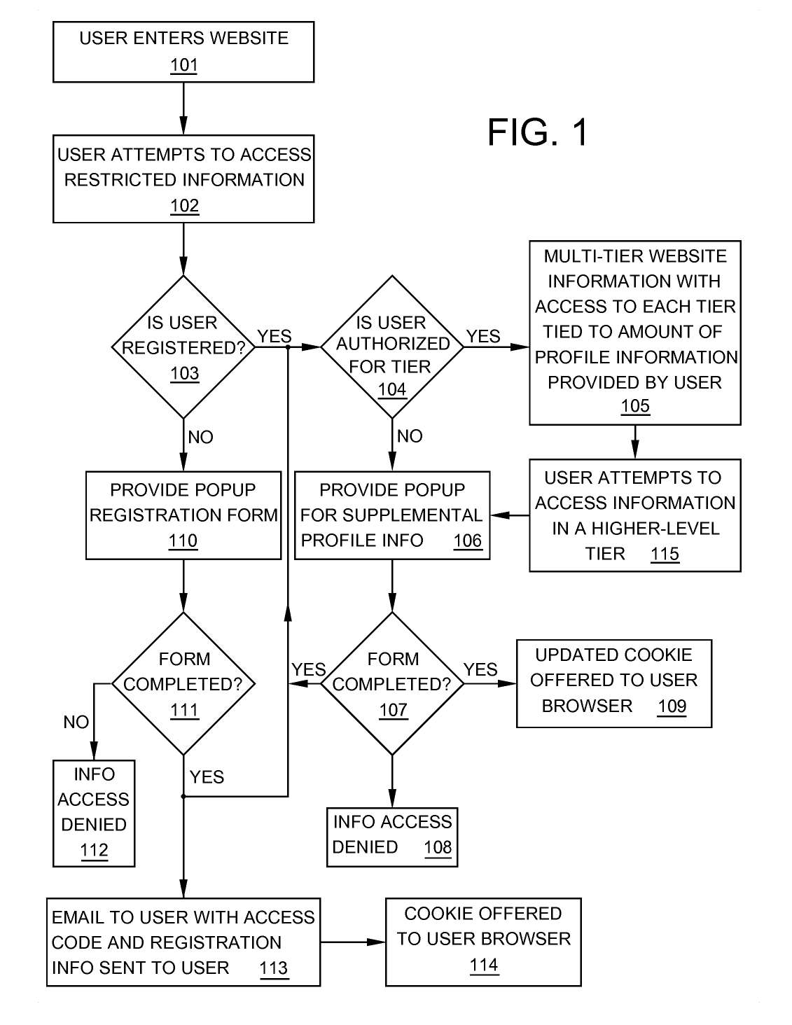

Referring now to FIG. 1, a user enters the Internet website of a subscribing entity in step 101. The user attempts to access valuable information within the website to which access is restricted in step 102. This attempt to access 102 triggers a link to the database server, which determines, in step 103, whether the user is registered with the database service. If the user is registered, the database service determines, in step 104, whether the user is authorized for the tier of information for which access has been attempted. If the user is authorized, he is immediately granted access up to the tier level of information in the multi-tier website database 105 for which he has been previously authorized. The authorized tier level is determined by the amount of profiling information that has been provided by the user to the database service.

Still referring to FIG. 1, if the hosting service determines, in step 103, that the user is not registered, a pop-up registration form is provided for completion by the user in step 110. If the user fails to complete the form, access to the restricted information on the website database 105, to which access has been attempted, is denied in step 112. On the other hand, if the hosting service determines, in step 111, that the user has completed the pop-up registration form, the hosting service may send an email to the user in step 113, which contains the user's access code and registration information. A cookie is also offered to the user's Internet browser in step 114. If the cookie is accepted, the user will be able to automatically access information in the accessed website and, optionally, in affiliated websites within the basic tier level within the multi-tier website database 105. After the pop-up registration form has been completed, the hosting service determines, in step 104, whether the information requested is within the basic level tier of information within the multi-tier website database 105. If the requested information is within the basic level tier, the user is given immediate access to the information. If not within the basic level tier, an additional pop-up form requesting supplemental profile information is provided for completion by the user in step 106. If the user fails to complete the form, he is denied access, in step 108, to information not pertaining to the basic tier level within website database 105, to which access has been attempted. On the other hand, if the hosting service determines, in step 107, that the user has completed the pop-up form requesting supplemental profiling information, the hosting service updates the user profile on its server and offers an updated cookie to the user's browser in step 109. If the updated cookie is accepted, the user will be able to automatically access information in the accessed website and, optionally, in affiliated websites up to the authorized higher tier level within the multi-tier website database 105.

Still referring to FIG. 1, as long as the user remains within or below his authorized information tier level with the multi-tier database 105, he can access any information at will. However, if the user, in step 115, attempts to access information in a higher level tier, a pop-up form is provided, in step 106, requesting supplemental profiling information required for the tier of information for which access was attempted.

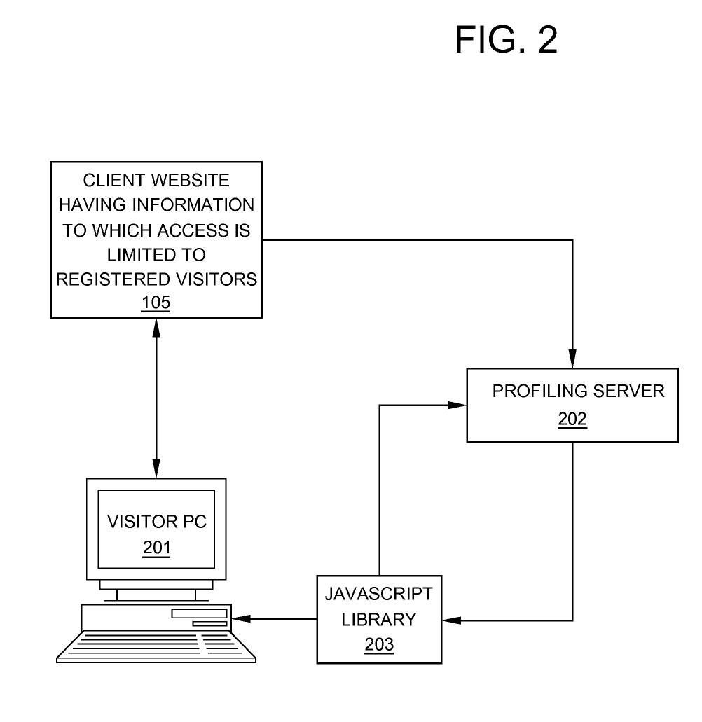

Referring now to FIG. 2, details are shown of the software implementation for the method and system for implementing progressive profiling of potential customers for the purpose of developing customer leads. Javascript library (JSL) instructions installed on the client website 105 communicate with the profiling server 202 of the hosting service, thereby establishing a relationship with the profiling server 202. When a visitor enters a client website 105, a Javascript library 203 is downloaded from the profiling server 202 to the Visitor PC 201. When the user clicks on any link of the client website 105, the Javascript Library 203 checks with the host server to determine the validity of the link status. If the user is not authorized to establish the requested link, the Javascript library 203, depending on link status, causes either a registration form or a supplemental information form to pop up on the user's screen. A cookie is offered to the user's browser or an existing cookie is updated once the form is completed. The Javascript library 203 sends to the profiling server 202 an on-going update of each link selected by the visitor. The profiling server 202 manages all set up, tracking, scoring, reporting and administration of the system for implementing progressive profiling of potential customers.

Progressive profiling can also be implemented or supplemented by forming behavioral conclusions about the visitor, based on the pattern of content selections while browsing the website (e.g., government-oriented clicks vs. private-sector-oriented clicks), and then adding that association to that visitor's stored profile. Progressive profiling of visitors can also be supplemented by allowing third-parties to contribute relevant data to existing profiles via an application programming interface. Such data may include answers to web site polls, survey questions, webinar participation statistics, and other information which assists in the identification of specific interests professional foci of particular visitors.

Tracking across any web service can be provided as long as those web services are called out by links or URL buttons associated with the base website. In other words, embedded constructs within the links or URL buttons enable the visitor to be handed off to another website, including webinar hosting services and social media websites and then returned to the base website when a particular off-site service is completed. Tracking of the visitors selections while on the off-site service can be maintained through the embedded constructs. In addition, embedded constructs can be contained within links in email solicitations sent to former website visitors and potential visitors. Those constructs can be used to track visitor preferences if the email recipient chooses to click on the link. The embedded constructs function independently of the email service provider. As long as a visit to a third-party web service is initiated within the base website through a link containing an embedded construct, or by means of a link in some other message or document (e.g. a delivered email message), which contains an embedded construct, tracking of activity of interested individuals can be implemented.

As information is received from a visitor, it is transferred to a database. As a rule, access to website content is restricted until a certain cumulative score threshold has been reached and the visitor has disclosed all desired information. Each visitor record contains a history of all website activity, downloads, and site visits. Database functions are used to score and rank leads as a function of accessed content and links, send automatic email messages, and take any other desired actions (including on-going customer campaigns). The scoring (raw values) and ranking (categorical values such as cold, warm, hot) of tracked activities are stored by visitor name. Scoring and ranking can be performed based on customer-specific business rules, based on best practice business rules, weighted by third party indices (e.g., consumer confidence index) or “climate” data (e.g., buying patterns by geography, culture, etc.). On a return visit, Web content can then be dynamically adjusted as a function of a visitor's profile, score, and rank. Such content may include welcoming information, as well as specific website content that is selected on the basis of a visitor's profile or profile category. In addition, a visitor's profile or profile category can be used to serve him with specific e-mail content or specific advertising campaigns.

The scope and coverage of profiling system can be enhanced by allowing affiliated, or partner, website owners to participate in a professional profiling exchange or interchange network. Within such a network, a visitor authenticated by one website would not be required to fill out an identifying and profiling form when visiting an affiliate website within the network. Profile data is shared by among partners or affiliates within the network based on a set of rules agreed to by all members of the network. Shared profile date can be limited to demographics, psychographics, behavioral data, scores, and similar data extractions. In such a network, the profile data is centrally owned and stored in a central location accessible to all network members (i.e., in the cloud).

Although only several embodiments of the new method and system for implementing progressive profiling of potential customers have been described herein, it should be obvious to those having ordinary skill in the art that changes and modifications may be made thereto without departing from the scope and the spirit of the invention as hereinafter claimed.

What is claimed is:

1. A method for profiling potential customers who access a website dedicated to at least one business topic, said method comprising the steps of:
restricting access of individual potential customers to valuable website content until that individual has registered by providing contact information, as well as information about his company and his position within that company to an online database; and
tracking that individual's access to website content in order to determine his needs and interests.

2. The method for profiling potential customers of claim 1, wherein an individual's access to website content is tracked by that individual's Internet Protocol (IP) address.

3. The method for profiling potential customers of claim 1, wherein whenever an unregistered individual attempts to access restricted website content, he is automatically directed to a registration page, which requests the desired information.

4. The method for profiling potential customers of claim 3, wherein once registration is completed, a long-term cookie is offered to the individuals Internet browser, which enables that individual to thereafter access restricted website content without having to manually log in.

5. The method for profiling potential customers of claim 3, wherein once registration is completed, the individual is automatically sent an email message which contains details of his registration, including an access code for future access to the website content to which access is restricted, thereby enabling an individual who has customized his Internet browser to reject cookies to gain access to the restricted information by manually inputting his login name and his access code.

6. The method for profiling potential customers of claim 1, wherein website content, to which access is restricted, is assigned multi-tier accessibility so that access to website content is allowed in stages, with each stage of allowance following the answering of particular questions by the individual.

7. The method for profiling potential customers of claim 6, wherein most desirable website content is made accessible only after collection of all essential information that is relevant to the efficient and accurate profiling of a potential customer.

8. The method for profiling potential customers of claim 1, wherein progressive profiling of individuals is supplemented by forming behavioral conclusions about the visitor, based on the pattern of content selections while browsing the website, and then adding that association to that visitor's stored profile.

9. The method for profiling potential customers of claim 8, wherein progressive profiling of individuals is further supplemented by allowing third-parties to contribute relevant data to existing profiles via an application programming interface, said relevant data including answers to web site polls, answers to survey questions, webinar participation statistics, and any other information which assists in the identification of specific professional interest foci of those individuals.

10. The method for profiling potential customers of claim 1, wherein embedded constructs within links of a base website enable a potential customer to be handed off to another website, which can include webinar hosting services and social media websites and then returned to the base website when a particular off-site service is completed, said embedded constructs also enabling tracking of visitor selections within the off-site service.

11. A method for profiling potential customers who access a website dedicated to at least one business topic, said method comprising the steps of:
restricting access of individual potential customers to valuable website content until that individual has registered by providing contact information, as well as information about his company and his position within that company to an online database;
tracking that individual's access to website content in order to determine his needs and interests;
maintaining a record for each potential customer, which includes not only contact and professional information, but a history of all website activity, downloads, and site visits; and
scoring and ranking each individual for suitability as a potential customer.

12. The method for profiling potential customers of claim 11, wherein scoring and ranking of each potential customer based on customer-specific business rules.

13. The method for profiling potential customers of claim 11, wherein scoring and ranking of each potential customer based on best practice business rules.

14. The method for profiling potential customers of claim 11, wherein scoring and ranking of each potential customer is weighted using third party indices selected from the group consisting of a consumer confidence index and purchase patterns analysis.

15. The method for profiling potential customers of claim 11, wherein website content available to a particular potential customer is dynamically adjusted as a function of a visitor's profile, score, and rank.

16. The method for profiling potential customers of claim 15, wherein adjustments to website content includes welcoming information, as well as specific website content that is selected on the basis of a visitor's profile or profile category.

17. The method for profiling potential customers of claim 15, wherein adjustments to website content includes using serving him with specific e-mail content and specific advertising campaigns.

18. The method for profiling potential customers of claim 11, wherein an individual's access to website content is tracked by that individual's Internet Protocol (IP) address.

19. The method for profiling potential customers of claim 11, wherein:
whenever an unregistered attempts to access restricted website content, he is automatically directed to a registration page, which requests the desired information;
once registration is completed, a long-term cookie is offered to the individuals Internet browser, which enables that individual to thereafter access restricted website content without having to manually log in; and
if an individual has customized his Internet browser to reject cookies, he is sent an email message which contains details of his registration, including an access code for future access to the website content to which access is restricted.

20. The method for profiling potential customers of claim 11, wherein:
website content, to which access is restricted, is assigned multi-tier accessibility so that access to website content is allowed in stages, with each stage of allowance following the answering of particular questions by the individual; and
most desirable website content is made accessible only after collection of all essential information that is relevant to the efficient and accurate profiling of a potential customer.
